(19) United States
(12) Patent Application Publication
(10) Pub. No.: US 2019/0044350 A1
(43) Pub. Date: Feb. 7, 2019

(54) Phonejuke Kiosk

(71) Applicant: PHONEJUKE INC, Great Neck, NY (US)

(72) Inventor: Rama Joshua Shadrokh, Great Neck NY, NY (US)

(21) Appl. No.: 15/727,608

(22) Filed: Oct. 8, 2017

Related U.S. Application Data
(60) Provisional application No. 62/409,398, filed on Oct. 18, 2016.

(51) Int. Cl. H02J 7/00

(52) U.S. Cl. CPC H02J 7/0027; G01G 19/00; H02J 7/0021; H02J 7/0018

(57) ABSTRACT

This invention relates to a system and apparatus for charging mobile devices alongside providing a personal storage space for certain permissible items. The invention also provides a mechanism for device detection into the secure compartments of the charging kiosk. The present invention is a portable and compact desk unit with wall mounting capability, highly suitable for areas with space restrictions.

### CROSS REFERENCE TO RELATED APPLICATIONS

This application claims the benefit of U.S. provisional application No. 62/409,398 filed on Oct. 18, 2016.

### BACKGROUND OF INVENTION

### Field of Invention

This invention relates to a system and apparatus for charging mobile devices alongside providing a personal storage space for certain permissible items.

### Description of Prior Art

Any discussion of documents, acts, materials, devices, articles or the like which has been included in this specification is solely for the purpose of providing a context for the present invention. It is not to be taken as an admission that any or all of these matters form a part of the prior art base or were common general knowledge in the field relevant to the present invention as it existed in the United States of America or elsewhere before the priority date of this application.

Often mobile device users forget to carry a charger while on the go or one might end up finding no electrical outlets for charging their devices especially while travelling. Many a times one prefers not to leave their devices unattended at public electrical charging outlets. Also, continued use of a mobile phone/portable electronic device without recharging the device's battery may deplete the battery and interrupt the use of the mobile phone/portable electronic device. At the same time, the mobile phone/portable electronic device's location may be inconvenient and/or unsafe for recharging the battery. For example, a user may receive a warning from his/her mobile phone after the mobile phone's battery levels fall below 15%. If the user continues using the mobile phone without charging the battery, the battery may run out of charge, and the mobile phone may switch off. Once the battery is dead, the user may be unable to restore operation of the mobile phone until the user has access to a suitable phone charger and/or power outlet. Moreover, the user may risk damage to and/or theft of the mobile phone if the user attempts to charge the mobile phone in public settings such as a restaurant, bar, airport, and/or gyms.

Consequently, uninterrupted use of mobile phones/portable electronic devices may be facilitated by mechanisms for securely charging the portable electronic devices in public settings. The present invention targets this problem by providing a system and apparatus for charging mobile devices while the user is on the go. The invention comprises of a portable, compact and wall mountable mobile device charging kiosk. While there are many phone charging kiosks in the market including Lastcall™ Chargers, NV3™ Technologies, Brightbox™, Mobilequbes™ & GoCharge™ but most of them are bulkier units installed at the subways, coffee shops, restaurants, casinos etc. The installation itself becomes cumbersome or nearly impossible at places where there are space restrictions. The present invention on the other hand offers a portable, compact desk unit and even wall mountable kiosk. Currently none of the phone charging kiosks in the market offers a personal storage option which often comes handy while the user is on the go and needs to store small items like wallets, keys, pens, glasses etc. The present invention addresses that problem by providing a personal storage space for small items. This feature allows users to keep their little items safely while their phone is charging in the kiosk.

Few of these applications discusses the concept of portable charging stations however none of these overcome the shortcomings discussed above. US Patent application US20140354214A1 to Phelps et al. (2014) discloses an invention which provides a charging station for portable electronic devices. However, the invention does not describe the mechanism for the detection of the presence of the mobile phone/portable electronic devices inside the secured compartment.

US patent application no. US 20150137759 to Palmer et al. (2015) discloses an apparatus for charging mobile devices comprising of a battery pack, a kiosk, a kiosk software and a battery pack apparatus for receiving, storing, charging and dispensing.

US patent application no US20160156207 to Frankenberger (2016) describes a mobile charging station comprising of a geo-locating system configured to identify the location of mobile charging station and to communicate the location of mobile charging station to a mobile service provider network.

US patent application no US20130132307 to Phelps et al. (2013) discloses an invention which pertains to the charging stations for portable electronic devices more specifically the invention describes the technique for managing the use of secured compartments in charging stations for portable electronic devices.

U.S. Pat. No. 9,203,245 B2 to Aloe (2015) describes an invention which is having a kiosk based battery rental system comprising of a kiosk and a server in electronic communication with each other, and a charging unit configured to charge at least one of a plurality of battery packs.

U.S. Pat. No. 8,718,717 to Vaknin et al. (2014) discloses an invention which pertains to a public cellular telephone charging station comprising of a housing mounted onto a support, a receptacle for receiving the cellular telephone, a circuits including timer and a charging port located within the receptacle.

After a thorough study of the aforesaid documents and more related ones, there is a need to develop and design a methodology that would address one or more drawbacks or insufficiencies of such systems and methods, thereby limiting their practical applications. The abovementioned problems leads to the current invention for the development of a phone charging kiosk which is more efficient to the prior art discussed as well as provide a better working system than previously described systems.

Besides many deficiencies in the abovementioned patent applications, the conventional phone charging kiosks have access cards to unlock the kiosk doors in case of emergencies and possibly lack mechanisms to manually open the kiosk door in case of power outages or other emergencies including failure of any electrical components inside the kiosk resulting in no ways left to extract the user's mobile device. The present invention besides access cards offers a manual release latch mechanism to open the doors manually in case of emergencies. Therefore, preventing the users from undue delays and offering a substantial improvement over the existing arts in this field.

### SUMMARY OF THE INVENTION

It is an object of the present invention to overcome, or substantially ameliorate, one or more of the disadvantages of the prior art, or to provide a useful alternative.

According to an aspect of the present invention; there is provided a portable, compact and wall mountable mobile device charging kiosk.

According to yet another aspect of present invention, there is provided a personal storage space which often comes handy while the user is on the go and needs to store small personal items like wallets, keys, pens, glasses or pretty much everything of the size that fits inside one's pocket. This feature allows users to keep their little items safely while their phone is charging in the kiosk.

According to yet another aspect of present invention, the compact and portable nature of the entire unit allows the kiosk to be installed at places where there are space restrictions. Since no bulkier units are involved, the installation is rather simple than the conventional counterparts.

According to another aspect of present invention; there is provided a manual release latch mechanism to open the doors of the compartments or slots manually in case of emergencies or electrical components failure inside the kiosk. This prevents the user from undue delays while extracting their devices.

Yet another object of the present invention deals with the presence of weight sensors in the secured compartments or slots in order to detect the presence of any device inside the charging kiosk.

Another embodiment of the present invention deals with the detection of weight sensors which further comprises of infra-red sensors for the detection of any device inside the secured compartments or slots.

According to yet another embodiment of the present invention, there is provided a mechanism in which the lack of detection of the user's device is queried to the user.

The features and advantages of the present invention will become further apparent from the following detailed description of preferred embodiments, provided by way of example only, together with the accompanying drawings.

### BRIEF DESCRIPTION OF DRAWINGS

FIG. 1 is a flowchart illustrating the steps implemented by the user to charge their mobile devices using the present invention.

FIG. 2 is a perspective view of the present invention.

FIG. 3 is a screenshot of the welcome screen while the user connects to the system.

FIG. 4 is a screenshot depicting the steps carried out by the user to charge their devices.

FIG. 5 depicts screenshots of the Phone charging sessions.

FIG. 6 depicts screenshots of door lock session.

FIG. 7 depicts screenshots of signing out session.

### DETAILED DESCRIPTION OF PREFERRED EMBODIMENTS

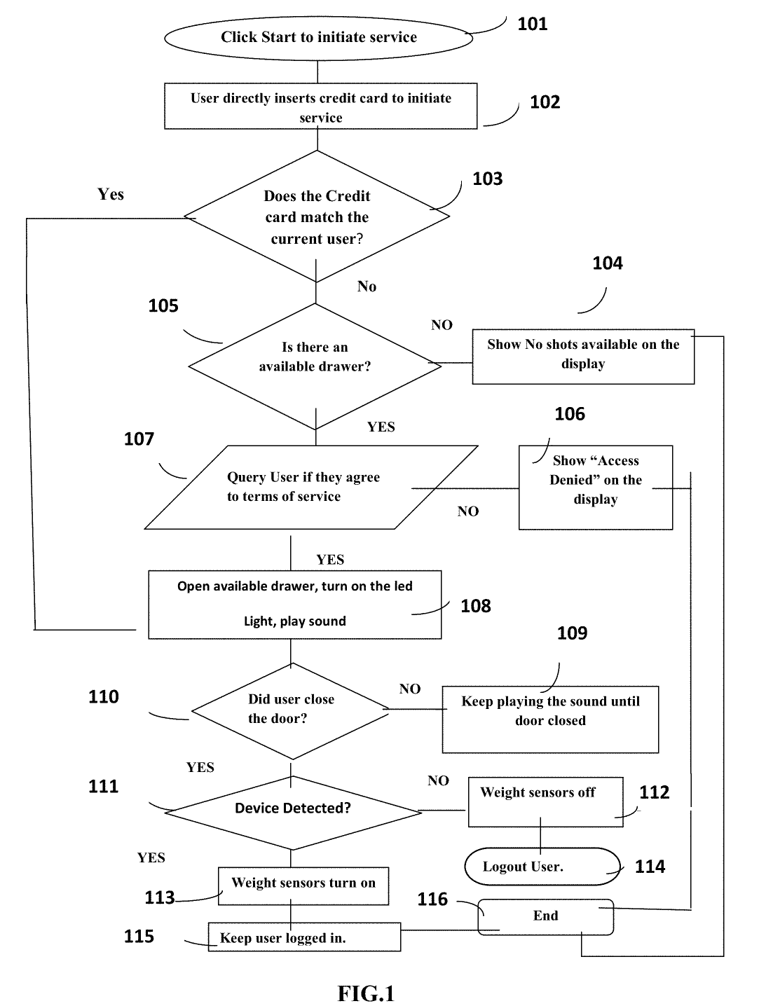

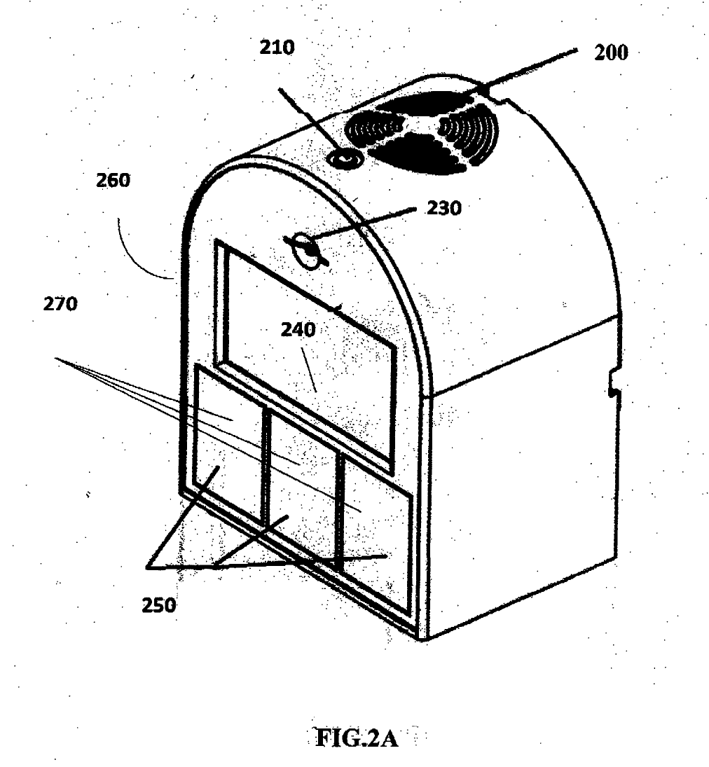

FIG. 1 illustrates the flowchart depicting the steps implemented by the user to charge their mobile devices using the present invention. The user press “start” at step 101 or alternatively inserts the credit card and directly initiates the service at step 102. The system authenticates the credit card with user details at step 103, in case of new user; the system registers the new user and asks the new users to “agree to terms and conditions” at step 107. If the user agrees, the system opens the doors of the available charging slots; turn on the LEDs and play sound at step 108; if not the system flashes “Access Denied” at step 106. Alternatively the system asks for “available drawers” at step 105 and flashes “No Slot available” message at step 104 in case no charging slots are free. In case the user is a returning client, the system directly unlocks the doors for the available charging slots or alternatively flashes “No Slot available” message in case no charging slots are free. The system confirms whether the user closed the door after keeping the mobile device for charging at step 110. In case the door is not closed, the system keeps playing the sound alert at step 109, till the user closes the door. In case the door is closed, the system detects the device at step 111. In case the device is detected, weight sensors turn on at step 113 and keep the user logged in as seen at step 115 ending the process at step 116. On the contrary if no device is detected, the weight sensors remain off as seen in step 112 and the user logs out at step 114 thus ending the process at step 116. While the applicant mentions “weight sensors” but it is to be understood that various modifications or variations of the same may be possible.

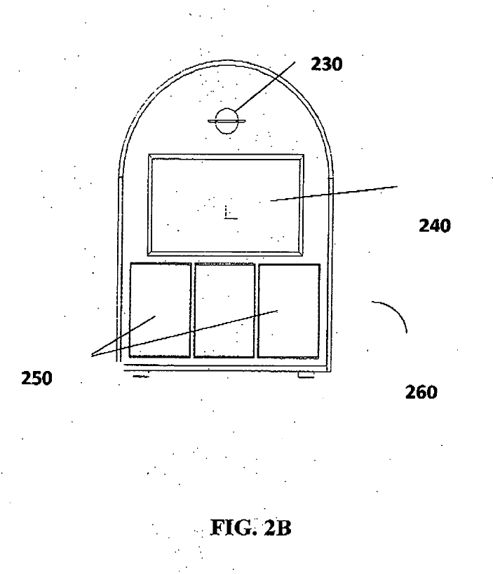

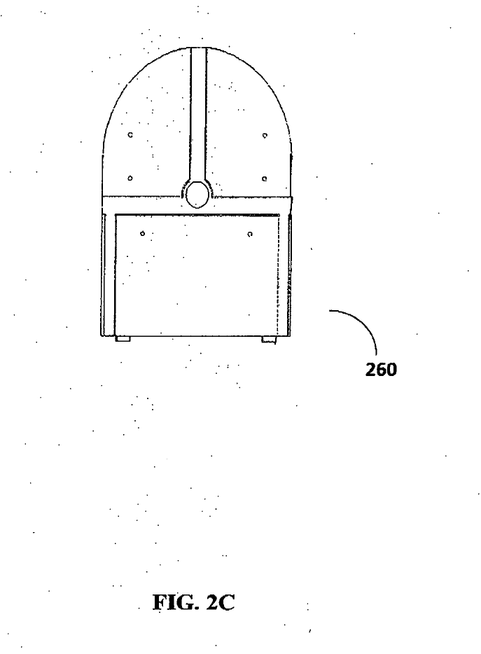

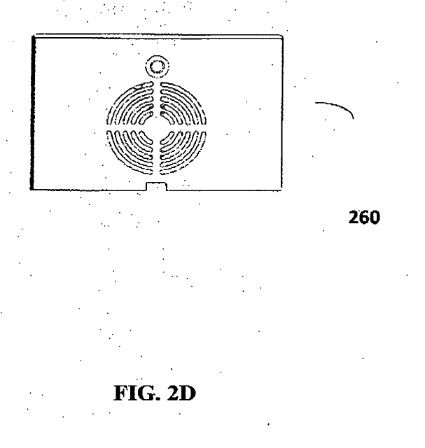

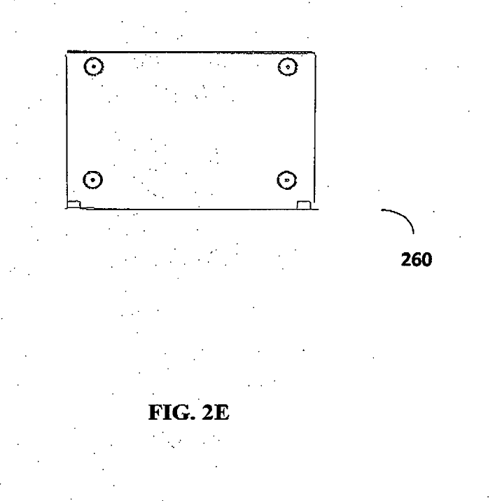

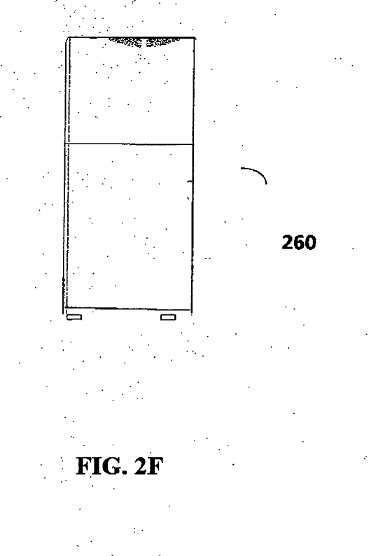

FIG. 2 illustrates a perspective view of the present invention. The user verifies his payment credentials by inserting the credit card in the card reader slot 230. The mobile device to be charged shall be put inside the slot 270 after opening one of the available doors 250 of the kiosk 260. The device has an air vent 200 at the top along with the monitor screen 240 in the front. The kiosk 260 is preferably of the dimensions 12.75″.wide×16.5″.tall×8.0″ deep. The kiosk 260 is portable desk unit, compact and wall mountable. There is also provided a personal storage option inside the slots 270 which often comes handy while the user is on the go and needs to store small personal items like wallets, keys, pens, glasses or pretty much everything of the size that fits inside one's pocket. This feature additionally allows users to keep their little items safely while their phone is charging. There is a provision of manual release latch mechanism to open the kiosk doors 250 manually in case of emergencies or electrical components failure inside the kiosk. This prevents the user from undue delays. The weight sensors underneath the charging slots 270 are electro-mechanical devices which sense the load or stress applied by the user mobile device as it is placed on the charging slot. Once these sensors turn on and detect the user device, the user is logged into the system and the mobile device starts charging as described in FIG. 1 flowchart. Apart from weight sensors, the present invention may employ Infra Red (IR) sensors but not limited to that, wherein by integrating an LED in the charging slot which produces light at the same wavelength as what the IR sensor requires, in order to detect the user's device. When an object i.e. user's device is in close proximity of the sensor, the light emitted from the LED bounce off the reflective object into the IR sensor. This results in a large jump in the intensity, which can be detected using a threshold. This enables the system to recognize the user device in the charging slot. In case other users tend to access already filled in slots, the systems flashes the warning “No Slots Available”. The screenshots will be discussed in detail as under.

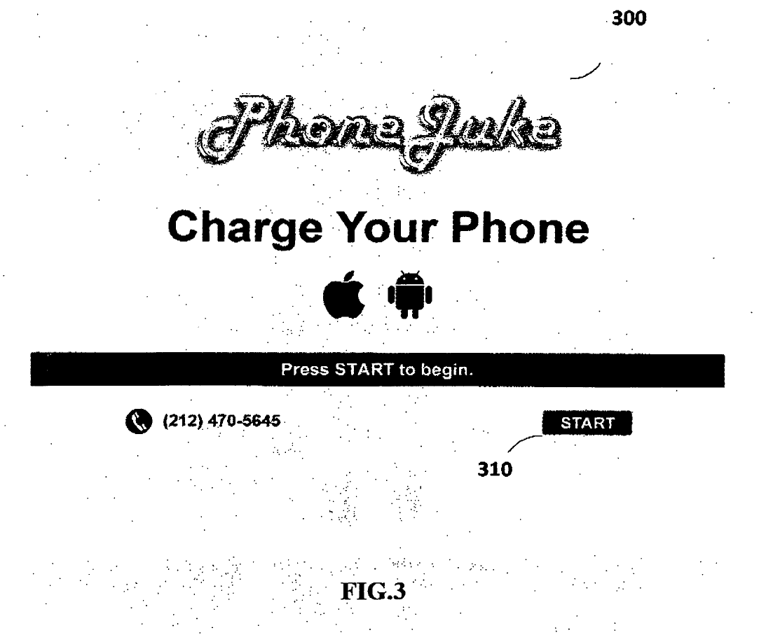

FIG. 3 illustrates the welcome screen 300 wherein the user clicks “Start” option 310 to access the system or alternatively insert the credit card directly to access the system.

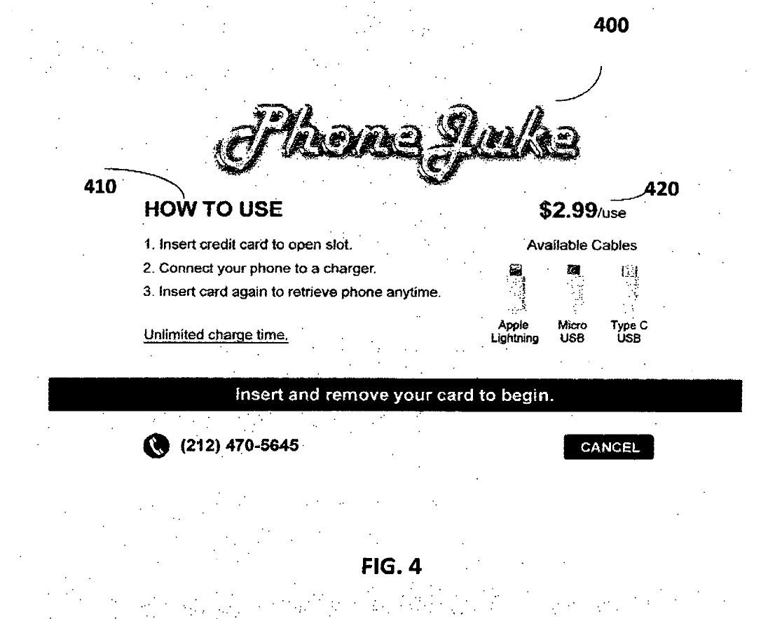

FIG. 4 illustrates the screenshot 400 wherein the user is updated with “How to Use” instructions 410 and payment info 420. “How to Use” instructions include: 1. Inserting the credit card to open the available slots; 2. Connecting mobile device to the charger in order to charge the concerned device; 3. The ending instructions include inserting the credit card again in order to retrieve the mobile device from the charging slot.

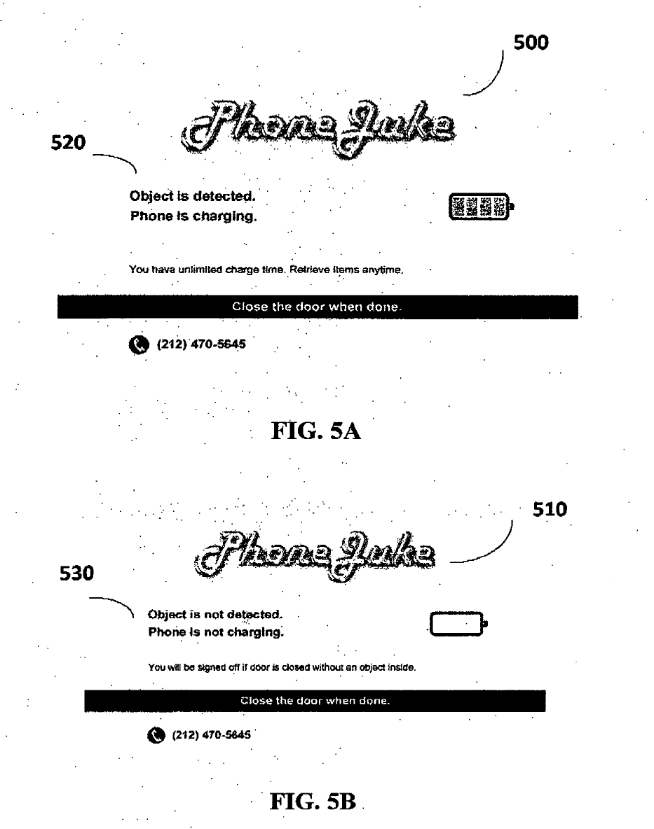

FIG. 5 illustrates screenshot 500 when the “object is detected and the device starts charging” 520. Screenshot 510 shows “no object detected and no charging” 530.

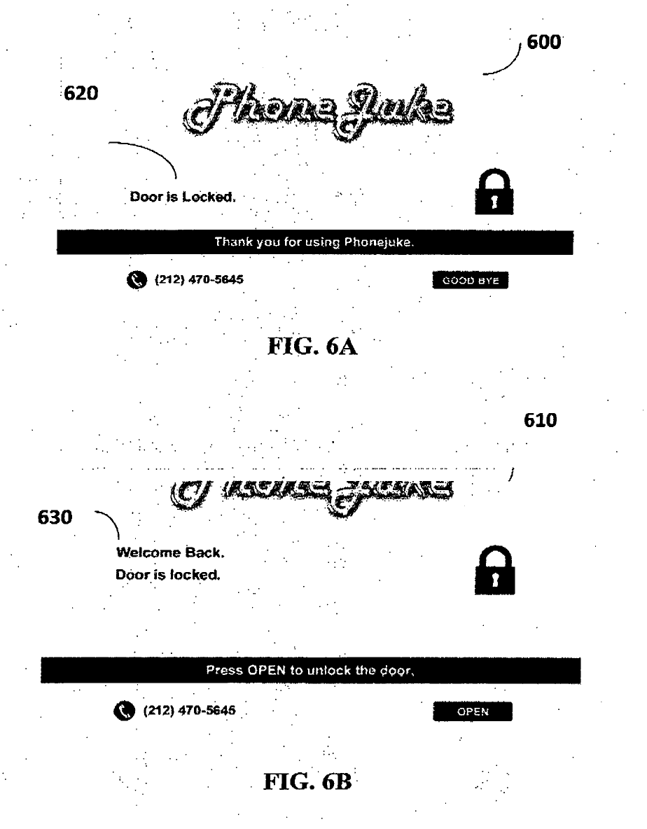

FIG. 6 illustrates screenshot 600 showing “Door is Locked” message 620 once the user is done placing the mobile device inside the charging slot. Screenshot 610 shows a welcome message and an “open to unlock the door” option 630 when the user attempts to retrieve their device after being charged.

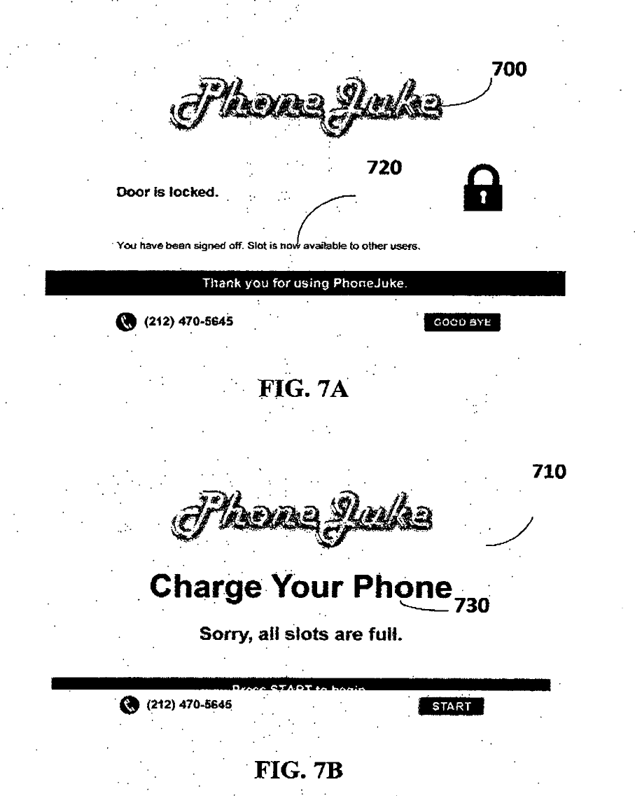

FIG. 7 illustrates screenshot 700 when the user signs out 720 and the slot is available to another user. Screenshot 710 shows “All slots are full” message 730 when no slot is available for charging the device.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

What is claimed is:

1. A portable mobile device charging kiosk, comprising:
a compact wall mountable unit wherein the mobile device to be charged is put inside the secured charging slots or compartments;
a monitor screen flashing the instructions to the user;
a personal storage space to store user's small personal items;
a manual release latch mechanism to open the doors of the compartments in case of emergencies.

2. A portable mobile device charging kiosk and its method of charging, wherein the system detects the device with the help of weight sensors in the secured compartments or slots of the charging kiosk.

3. A portable mobile device charging kiosk according to claim 1, wherein the kiosk dimensions are preferentially 12.75″.wide×16.5″.tall·8.0″ deep. The charging kiosk is a portable desk unit, compact and wall mountable.

4. A portable mobile device charging kiosk wherein there is provided a personal storage space for the users in order to store small personal items. This feature allows users to keep their little items safely while their phone is charging in the kiosk.

5. A portable mobile device charging kiosk according to claim 3, wherein there is a provision of manual release latch mechanism to open the kiosk doors manually in case of emergencies or electrical components failure inside the kiosk. This prevents the user from undue delays.

6. A portable mobile device charging kiosk according to claim 2, wherein the weight sensors underneath the charging slots are electro-mechanical devices which sense the load or stress exerted by the user device as it is placed on the charging slot.

7. The method of charging according to claim 2, wherein once the sensors turn on and detect the user's device, the user is logged into the system and the mobile device starts charging.

8. The method according to claim 7, wherein the lack of detection of the user's device in the charging slot turns off the sensors and the user is logged out.

9. The method according to claim 8, wherein upon the detection of the user device in the charging slot, the weight sensors turn on and keep the user logged in.

10. The method according to claim 2, wherein the system authenticates and registers the transaction details of the new user before opening the doors of the available charging slots.

11. The method according to claim 10, wherein the system denies access to the charging kiosk in case the charging slots are full or unavailable.
